(19) United States
(12) Patent Application Publication
(10) Pub. No.: US 2008/0114857 A1
(43) Pub. Date: May 15, 2008

(54) Method and apparatus for advertising using an electronic gateway

(76) Inventor: Eric J. Snider, Peoria, AZ (US)

Correspondence Address: Eric J Snider, 7134 W Lariat Lane, Peoria, AZ, 85383, US

(21) Appl. No.: 11/599,668

(22) Filed: Nov. 15, 2006

(51) Int. Cl. G06F 15/16

(52) U.S. Cl. 709/217

(57) ABSTRACT

A method and apparatus for providing information stored in a networking device responsive to communication requests from a client. In one embodiment, a method may include receiving communication requests from a client at a networking device, and providing information stored in the networking device to the client responsive to the communication requests from the client. In another embodiment, an apparatus may include a networking device operable to communicate with a plurality of clients and to provide information stored in the networking device to the plurality of clients responsive to communication requests from the plurality of clients.

### TECHNICAL FIELD

This invention relates to the field of data networking. More specifically, this invention relates to advertising the information stored in a networking device.

### BACKGROUND

With the prevalence of networked computer systems such as the Internet, obtaining information on a given topic can be as convenient and simple as surfing the World Wide Web (“the web”) on a network-connected computer. Given the popularity of mobile devices, such as laptop/notebook personal computers, personal digital assistants (PDA), mobile phones, portable gaming consoles, and any sort of portable electronic devices that are capable of Internet access, accessing information from the web at a location other than one's office or home is increasingly becoming a reality for more and more people. Nevertheless, before network access becomes omnipresent in our daily life regardless of time and location, advertising information to the pubic and, likewise, obtaining information on a given topic may still be done in traditional ways.

For example, when looking for a real property to purchase, one would normally obtain from one's real estate agent a listing of real properties matching one's criteria, such as price, location, size of lot, number of bedrooms, school district, etc. Alternatively, with the convenience of the Internet, one could key in search criteria at any of the numerous real estate websites to search for real properties meeting one's search criteria Moreover, one could drive around in a neighborhood of interest to look for real properties with “for sale” signs, and obtain a data sheet on the real property. However, unless there is an open house where a real estate agent is present inside a real property that is for sale, or unless there is any data sheet left for pickup, one would not be able to obtain detailed information on a real property even when one is outside on the curb of the real property.

In another example related to real estate, new homes are sometimes built at large sites where models are built first and prospective buyers walk through the models to determine which model they would like to purchase. Often times, a agent of the home builder or site developer would present in one of the model homes to greet visitors, answer questions, and provide printed information on any or all of the different models to the visitors. However, people visiting a development site after hours would not have the luxury to visit the inside of a model home, be greeted by an agent, or obtain information on one or more of the different models.

In a different context, a common way for one to find out what dishes are served by a restaurant is usually by reading the restaurant's menu. However, unless one physically visits a restaurant, one often does not know what is on the restaurant's menu unless it is a restaurant that one frequents. Although one could visit a restaurant's website to look for the restaurant's menu, in most cases people go to a restaurant not having checked out the restaurant's website and not knowing what dishes are served by the restaurant.

In the above examples, besides talking to an agent or a restaurant waiter/waitress, one would usually obtain information is the traditional form of text or text/graphics on printed paper. Such form of information conveyance is subject to at least a few limitations. First, one would need to physically obtain the piece or pieces of paper containing the information; and such is subject to the availability of printed materials as well as the hours of operations of the information provider if printed materials can only be obtainable when the information provider is open for business. Second, sometimes description by text or text-plus-graphics alone is not sufficient to convey the significance and benefits of what is being advertised. Third, once advertising information is printed on paper it is hard to update the pre-printed information with any changes. Fourth, printing costs money. Fifth, any new update to the printed material means time for printing of new materials. Last but not least, there is no “interactive viewing” mechanism built in paper-based information conveyance such that a viewer can delve into more details or navigate to related information as one would be able to when viewing websites on the Internet. It would be convenient to both the information providers and information viewers if advertised information can be accessible, wirelessly or otherwise, at any time by portable devices in the form of video, audio, text and graphics.

### SUMMARY OF THE INVENTION

According to one embodiment of the present invention, a method includes receiving communication requests from a client at a networking device, and providing information stored in the networking device to the client responsive to the communication requests from the client. According to another embodiment of the present invention, an apparatus includes a networking device operable to communicate with a plurality of clients and to provide information stored in the networking device to the plurality of clients responsive to communication requests from the plurality of clients.

### BRIEF DESCRIPTION OF THE DRAWINGS

The present invention is illustrated by way of example, and not by way of limitation, in the figures of the accompanying drawings and in which:

FIG. 1 illustrates one embodiment of a network architecture.

FIG. 2 illustrates one embodiment of receiving HTTP requests from a client at a networking device, redirecting the HTTP requests to the networking device, and providing information stored in the networking device to the client.

FIG. 3 illustrates one exemplary web page showing contents stored in the networking device.

### DETAILED DESCRIPTION

Described herein is a method and apparatus for receiving communication requests from a client to a networking device and providing information stored in the networking device to the client responsive to the communication requests from the client. The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram form in order to avoid unnecessarily obscuring the present invention. Thus, the specific details set forth are merely exemplary. Particular implementations may vary from these exemplary details and still be contemplated to be within the spirit and scope of the present invention.

Embodiments of a method and apparatus are described to redirect communication requests from a client to a networking device and provide information stored in the networking device to the client responsive to the communication requests from the client. In one embodiment, a method may include receiving communication requests from a client at a networking device, and providing information stored in the networking device to the client responsive to the communication requests from the client. In another embodiment, an apparatus may include a networking device operable to communicate with a plurality of clients and to provide information stored in the networking device to the plurality of clients responsive to communication requests from the plurality of clients.

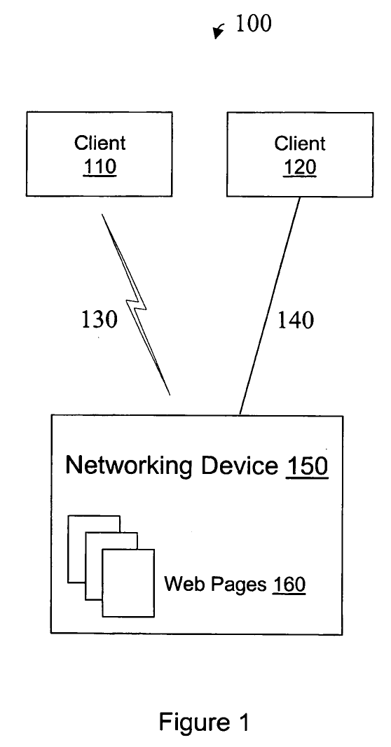

FIG. 1 illustrates an exemplary network architecture 100 in which embodiments of the present invention may operate. The network architecture 100 may include clients 110 and 120 coupled with a networking device 150 via wireless communication 130, using protocols such as the Institute of Electrical and Electronics Engineers (IEEE) 802.11 standards (including, but not limited to IEEE 802.11a, 802.11b, and 802.11g, with the notion of 802.11x denoting any one of the 802.11 standards) or other similar wireless communication protocols, and wired communication 140, by using a wire such as an Ethernet Category 5 cable. Although both clients 110 and 120 are present in FIG. 1, networking device 150 may be communicating with clients 110 and 120 separately at different times or simultaneously. Moreover, although only clients 110 and 120 are illustrated, networking device 150 may be communicating with more clients that are similar to clients 110 and 120. The clients 110 and 120 may be, for example, personal computers (PCs), mobile phones, palm-sized computing devices, personal digital assistants (PDAs), etc. that are capable to communicate with the networking device 150 via any of the methods described above. Whether a client communicates with the networking device 150 via wireless communication or wired communication depends on the capability of the client.

The networking device 150 may be an electronic gateway, such as a router, that is capable to serve as an entrance from one network to another network and is equipped to interface with another network that uses different networking protocols. The networking device 150 may be capable to perform tasks that are traditionally performed by various specific-purpose servers in a network. For example, in one embodiment, the networking device 150 may be configured to function as a Dynamic Host Configuration Protocol (DHCP) server, a Domain Name System (DNS) server, and a Hypertext Transfer Protocol (HTTP) server in that the networking device 150 is capable to perform the tasks of assigning Internet Protocol (IP) address to clients, redirecting HTTP requests from clients to any of a plurality of web pages 160 that are stored in the networking device 150, and to provide contents of those web pages to the clients. Although the networking device 150 may function as an electronic gateway, it is not connected to any network and will only connect with clients that establish communications with it. Once a communication is established between a client and the networking device 150, the networking device 150 redirects any HTTP request from the client that does not request to access a resource having a Uniform Resource Identifier (URI) or Uniform Resource Locator (URL) that matches the URI or URL of any of the web pages 160 stored in the networking device 150 to a home web page that is also stored in the networking device 150. If an HTTP request from the client requests to access a resource having a URI or URL that identifies the URI or URL of any of the web pages 160 that are stored in the networking device 150, the networking device 150 will redirect the HTTP request to the identified web page. Subsequently, the contents of the home web page or the identified web page, depending on the case, will be provided to the client from the networking device 150.

In one embodiment, a client, such as client 110, communicates wirelessly with the networking device 150 using IEEE 802.11x standard. Since the detail of communications in any of the IEEE 802.11 standards is well known in the art, in the interest of brevity the following description in the next paragraph will focus only on the major events that occur during the wireless communication between the client 110 and the networking device 150.

To enable a client to wirelessly communicate with itself, the networking device 150 broadcasts it Service Set Identification (SSID). Depending on how the client 110 is configured, the client 110 either automatically connects up to the networking device 150 upon the detection of the SSID of the networking device 150, or the user of the client 110 needs to manually configure the client 110 to allow connection to the broadcast SSID of the networking device 150. Once the wireless client 110 connects to the SSID of the networking device 150, the client 110 sends a DHCP discover message to the networking device 150. Upon receiving the DHCP discover message, the networking device 150, functioning as a DHCP server, responds to the client 110 with a DHCP offer message, consisting of not just an IP address assigned to the client 110, but also a subnet mask (DHCP option 1), default gateway (DHCP option 3), and other DHCP options such as DNS server (DHCP option 6), DHCP lease time (DHCP option 51), and DHCP server identifier (DHCP option 54) identifying the IP address of the DHCP server, which is the networking device 150 itself. Once the client 110 receives the DHCP offer message from the networking device 150, it further sends a DHCP request to the networking device 150 asking for an IP address and the aforementioned DHCP options. In response, the networking device 150, functioning as a DHCP server, sends a DHCP acknowledgement message to the client 110, telling the client 110 that the requested IP address has been assigned. When the user of the client 110 launches a user interface on the client 110, the client 110 contacts the DNS server (which is the networking device 150 functioning as a DNS server) that is identified in DHCP option 6 to get name resolution from a fully qualified domain name (FQDN) to an IP address. In one embodiment, the user interface may be a web browser. Correspondingly, the networking device 150, functioning as a DNS server, resolves all FQDN requests to the IP address of the networking device 150 itself. Because the networking device 150 also functions as a HTTP server, when the client 110 launches a web browser and enters an FQDN to any web page, the networking device 150 will process the HTTP requests from the client 110 and launch the default web page that is defined on the networking device 150. As a result, the contents of the default web page stored in the networking device 150 will be shown in the web browser on the client 110.

In another embodiment, a client, such as client 120, communicates with the networking device 150 with a wire. In one embodiment, the client 120 communicates with the networking device 150 using Ethernet technology based on IEEE 802.3, and the wire may be a Category 5 cable. Since the detail of communications in IEEE 802.3 is well known in the art, in the interest of brevity the following description in the next paragraph will focus only on the major events that occur during the wireless communication between the client 120 and the networking device 150.

To enable a client to communicate with itself via a wire, the networking device 150 may have a Category 5 cable connected to an Ethernet port of the networking device 150 on one end, and accessible for a user of the client 120 to connect to the client 120 on the other end. Once the cable is connected to an Ethernet port of the client 120, the physical connection is recognized by the client 120. When the client 120 recognizes the physical connection, the client 120 sends a DHCP discover message to the networking device 150. Upon receiving the DHCP discover message, the networking device 150, functioning as a DHCP server, responds to the client 120 with a DHCP offer message, consisting of not just an IP address assigned to the client 120, but also a subnet mask (DHCP option 1), default gateway (DHCP option 3), and other DHCP options such as DNS server (DHCP option 6), DHCP lease time (DHCP option 51), and DHCP server identifier (DHCP option 54) identifying the IP address of the DHCP server, which is the networking device 150 itself. Once the client 120 receives the DHCP offer message from the networking device 150, it further sends a DHCP request to the networking device 150 asking for an IP address and the aforementioned DHCP options. In response, the networking device 150, functioning as a DHCP server, sends a DHCP acknowledgement message to the client 120, telling the client 120 that the requested IP address has been assigned. When the user of the client 120 launches a user interface on the client 120, the client 120 contacts the DNS server (which is the networking device 150 functioning as a DNS server) that is identified in DHCP option 6 to get name resolution from a fully qualified domain name (FQDN) to an IP address. In one embodiment, the user interface may be a web browser. Correspondingly, the networking device 150, functioning as a DNS server, resolves all FQDN requests to the IP address of the networking device 150 itself. Because the networking device 150 also functions as a HTTP server, when the client 120 launches a web browser and enters an FQDN to any web page, the networking device 150 will process the HTTP requests from the client 120 and launch the default web page that is defined on the networking device 150. As a result, the contents of the default web page stored in the networking device 150 will be shown in the web browser on the client 120.

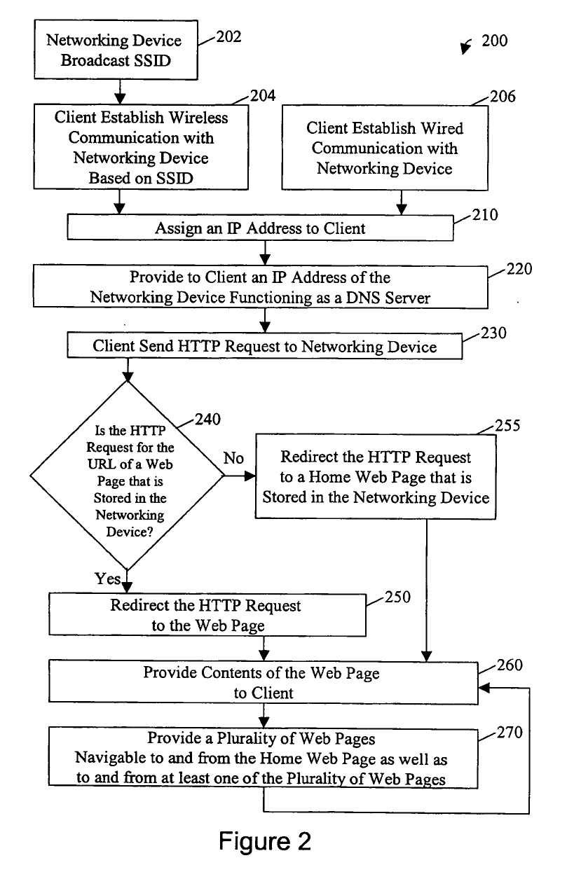

FIG. 2 illustrates a flow diagram of one embodiment of a process 200 for redirecting communication requests from a client to a networking device and providing information stored in the networking device to the client in response to the communication requests from the client. The process may be performed by processing logic that may comprise hardware (e.g., circuitry, dedicated logic, programmable logic, microcode, etc.), software (such as instructions run on a processing device), firmware, or a combination thereof. In one embodiment, process 200 is performed by networking device 150 of FIG. 1.

Referring to FIG. 2, in one embodiment, process 200 begins with establishing communication between a client and the networking device 150 (blocks 202, 204 and 206). In the case of wireless communication, the networking device 150 broadcasts its SSID (block 202). Upon detecting the SSID of the networking device 150, a wireless-enabled client establishes wireless communication with the networking device 150 based on the SSID (block 204). In the case of wired communication, a client establishes communication with the networking device 150 simply by connecting to the networking device via physical connection such as a cable (block 206).

Upon establishment of communication with the client, the networking device assigns an IP address to the client (block 210). The networking device 150 also provides to the client the IP address of the networking device 150 functioning as a DNS server (block 220). When the user of the client launches a user interface on the client, the client correspondingly sends a HTTP request to the networking device functioning as a DNS server (block 230). In one embodiment, the user interface may be a web browser. The networking device 150, functioning as a DNS server, determines whether the HTTP request is for access to a resource location (e.g., URL) that is one of the web pages stored in the networking device 150 (block 240). If the HTTP request is for one of the web pages stored in the networking device 150, the networking device 150 redirects the request to the identified web page (block 250). If the HTTP request is not for any of the web pages stored in the networking device 150, the networking device 150 redirects the request to a designated home web page among the web pages stored in the networking device 150 (block 255). The networking device 150, functioning as a HTTP server, then provides to the client the contents of the web page where the HTTP is redirected to (block 260). Each of the web pages stored in the networking device 150 is accessible from the home web page as well as from one or more of the other web pages (block 270).

As a result of the process illustrated in FIG. 2, when a client starts communicating with the networking device 150 and a user interface is launched on the client, the networking device 150 will cause the user interface to display the contents of a web page that is stored in the networking device 150. The user of the client can view the contents of the web page and navigate from the web page to other web pages that are stored in the networking device 150. However, if the user of the client enters into the user interface a URL that is not the URL of any of the web pages stored in the networking device 150, the networking device 150 will redirect the corresponding HTTP request to the home web page that is stored in the networking device 150. Therefore, a user of a client that is communicating with the networking device 150 can access contents of the web pages that are stored in the networking device 150 but not any information that is not already stored in the networking device 150.

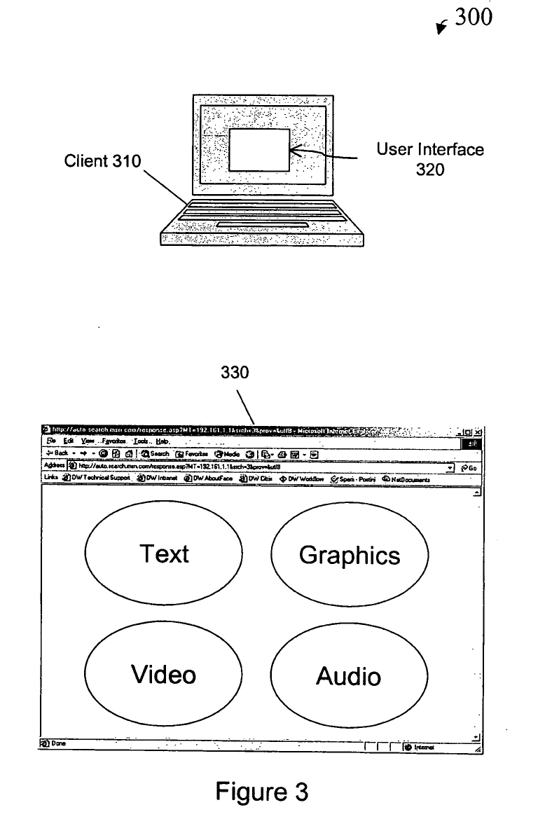

In one embodiment, the user interface (UI) on a client, through which a user views contents of a web page and navigates from one web page to another, may be a web browser. FIG. 3 illustrates an exemplary UI displayed on a client 310.

Referring to FIG. 3, a client 310 may include a UI 320, and UI 320 may include a web browser 330 that displays the contents of a web page that is stored in the networking device 150. The contents of a web page that is stored in the networking device 150 may include video, text, audio, graphics, or any combination thereof. In one embodiment, the contents may be advertising information.

In one embodiment, in a real estate scenario where an existing home is put on the market for sale, a networking device such as the networking device 150 may be used to advertise the house and provide detailed information about the house. The detailed information may include video clips featuring the interior and exterior of the house, audio clips that may be part of the video clips or independent of the video clips that may feature a real estate agent talking about the house and/or the real estate agency, and any textual information and graphics related to the house. In one example, a potential house buyer driving to the curbside of the house may access all the aforementioned information from a networking device, such as the networking device 150, located inside the house for sale, by using a wireless-capable portable device, such as a laptop or a PDA. As such, a potential buyer can come by the house at anytime without regard to the open-house hours, the availability of the real estate agent, and the availability of flyers describing the house.

In one embodiment, in a real estate market scenario where newly-built homes and/or model homes are for sale, a networking device such as the networking device 150 may be used to advertise the new/model homes and provide detailed information about the new/model homes. Similarly to what's described in the previous scenario, a potential home buyer may come to the curbside of a new/model home, in which there is a networking device such as the networking device 150, at any time of the day to obtain detailed information about the new/model home of interest.

In another embodiment, in a restaurant scenario, a networking device such as the networking device 150 may be used to advertise the restaurant's menu as well as pictures of the entrees on the menu. Besides menu and pictures of entrees, the networking device may also contain video clips of people, such as customers of the restaurant, owner of the restaurant, or food critiques, making comments on the restaurant and its food and services. The networking device may also contain audio clips. As such, in one example, a person deciding which restaurant to go to for a meal may preview the restaurant's menu and review the comments in making the decision without having to physically go to the restaurant, if the person has a wireless-enabled portable device and is within the wireless communication range of a networking device that advertises the restaurant.

In an alternative embodiment, a networking device such as the networking device 150 may be used to serve as a repository of blueprint and floor plan of a commercial building for the Fire Department or Police Department to access such information in case of emergency (e.g., fire, hostage situation, etc.). The officials in such case can therefore access the needed information without having to access the print version of the information that is usually kept inside the building.

In yet another embodiment, a store having moved from one location to another may wish to provide map and direction to its new location to any customer. Again, a networking device such as the networking device 150 may be used to provide such information as well as other advertisement about the store and its merchandise.

In yet another embodiment, before a store will be opened, its owner may wish to advertise jobs to potential job seekers as well as advertise to future customers about the store and its merchandise/services. Once again, a networking device such as the networking device 150 may be used to advertise such information.

Thus, a method and apparatus for receiving communication requests from a client to a networking device and providing information stored in the networking device to the client responsive to the communication requests from the client have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method, comprising:
receiving communication requests from a client at a networking device;
providing information stored in the networking device to the client responsive to communication requests from the client.

2. The method of claim 1, wherein the networking device operable to assign an Internet Protocol (IP) address to the client, to redirect Hypertext Transfer Protocol (HTTP) requests from the client to a home web page stored in the networking device, and to provide contents of the home web page to the client.

3. The method of claim 2, wherein receiving communication requests from a client at a networking device comprises assigning an Internet Protocol (IP) address to the client by the networking device.

4. The method of claim 3, further comprising providing an IP address of the DNS server to the client by the networking device.

5. The method of claim 4, wherein the communication requests from the client comprise Hypertext Transfer Protocol (HTTP) requests from the client.

6. The method of claim 5, wherein providing information stored in the networking device to the client responsive to communication requests from the client comprises:
redirecting HTTP requests from the client to a home web page stored in the networking device; and
providing contents of the home web page to the client.

7. The method of claim 6, wherein redirecting the HTTP requests from the client to the home web page stored in the networking device comprises redirecting any HTTP request for a Uniform Resources Locator (URL) other than the home web page's URL to the home web page.

8. The method of claim 7, wherein the networking device operable to communicate with a plurality of clients and to provide information stored in the networking device to the plurality of clients responsive to HTTP requests from the plurality of the clients.

9. The method of claim 8, wherein the contents of the home web page comprise a combination of video, text, audio and graphics.

10. The method of claim 8, further comprising:
allowing a plurality of web pages stored in the networking device navigable to and from the home web page as well as to and from at least one of the plurality of web pages; and
providing contents of one of the plurality of web pages to the client when accessed by the client.

11. The method of claim 10, wherein the contents of each of the plurality of web pages comprise a combination of video, text, audio and graphics.

12. The method of claim 8, wherein the networking device comprises an electronic gateway capable of wireless communications with the client.

13. The method of claim 12, wherein the wireless communications comprise wireless communications based on Institute of Electrical and Electronics Engineers (IEEE) 802.11.

14. The method of claim 8, wherein the networking device comprises an electronic gateway capable of wired communications with the client.

15. The method of claim 14 wherein the wired communications comprise communications transmitted over an Ethernet cable between the networking device and the client based on IEEE 802.3.

16. An apparatus, comprising:
a networking device, the networking device operable to communicate with a plurality of clients and to provide information stored in the networking device to the plurality of clients responsive to communication requests from the plurality of clients.

17. The apparatus of claim 16 wherein the networking device operable to assign an Internet Protocol (IP) address to each of the plurality of clients, to redirect Hypertext Transfer Protocol (HTTP) requests from the plurality of clients to a home web page stored in the networking device, and to provide contents of the home web page to the plurality of clients.

18. The apparatus of claim 17 wherein the contents of the home web page comprise a combination of video, text, audio and graphics.

19. The apparatus of claim 17 wherein the networking device comprises an electronic gateway capable of wireless communication with the plurality of clients.

20. The apparatus of claim 17 wherein the networking device comprises an electronic gateway capable of wired communication with at least one of the plurality of clients.
